(19) United States
(12) Patent Application Publication
(10) Pub. No.: US 2004/0231493 A1
(43) Pub. Date: Nov. 25, 2004

(54) Modular drumstick

(76) Inventors: Mark Geoffrey Milne, Kilmacolm (GB); Hugh Gill, Paisley (GB)

Correspondence Address: Benesch Friedlander Coplan & Aronoff, 2300 BP Tower, 200 Public Square, Cleveland, OH, 44114-2378, US

(21) Appl. No.: 10/483,171

(22) PCT Filed: Jul. 4, 2002
(86) PCT No.: PCT/GB02/03054

(30) Foreign Application Priority Data
Jul. 6, 2001 (GB) 0116488.8
Dec. 18, 2001 (GB) 0130142.3

(51) Int. Cl. G10D 13/02

(52) U.S. Cl. 84/422.4

(57) ABSTRACT

A modular drumstick (1, 100) is comprised of an elongate body (4, 104) and a handle (2, 102) which are removably attached to one another. The drumstick (1, 100) also has three interchangeable weight inserts (24, 124, 26, 126, 28, 128) removably attached thereto at distinct points along its length. By attaching weights of different mass at the distinct points along the stick, the user may adapt the balance, rebound and other performance characteristics of the drumstick.

The present invention relates to a drumstick to which a number of interchangeable weight inserts and striking members may be added to vary certain performance characteristics thereof.

At present, different types of drumstick are available which have particular performance characteristics that are particularly suitable for playing certain types of music such as rock, jazz, orchestral pieces or marching band music, for example Drumsticks are generally constructed as a single homogenous unit with a striking element that. is determined by the purpose of musical type for which the drumstick is intended. The striking elements include a variety of drumstick tips of varying shapes and material compositions as well as. steel or nylon brush elements, felt beaters or mallets.

Drummers and percussionists who do not specialise in one particular type of music will encounter a variety of musical situations that require an extensive range of drumsticks/beaters. These must be selected from a large range of manufactured items to allow the user to select the drumstick or beater of the user's preference in terms of overall weight, balance, tip type and feel. Manufacturers therefore supply a vast range of drumsticks and beaters, and accordingly distributors and stockists attempt to supply this comprehensive range.

One part solution to this problem has been to provide drumsticks or beaters that have interchangeable frontstick elements, that is the portion of the stick ahead of the handle which actually comprises the striking element. However, although this allows the drummer to reduce the number of sticks and beaters he carries, he must still carry a number of sticks if he wishes to vary the performance characteristics (e.g. weight, balance and rebound) of the stick.

It is therefore an aim of the present invention to obviate or mitigate one or more of the aforementioned problems.

According to the present invention, there is provided a modular drumstick comprising:

an elongate body having a first end and a second end;

an elongate handle having a first end and a second end;

wherein the first end of the body and second end of the handle are adapted so that the handle may be removably attached to the body such that the first end of the body and second end of the handle are connected to one another; and

the drumstick further comprising first, second and third weight inserts which are adapted to be removably attached to the drumstick at first, second and third locations, respectively, along the length thereof.

Preferably, the first location is adjacent the first end of the handle, the second location is adjacent the second end of the handle and the first end of the body, and the third location is adjacent the second end of the body.

Preferably, an annular damping member is provided between at least one of the weight inserts and the drumstick.

Preferably, the first and third weight inserts are provided with chambers into which may be inserted metal members of differing mass. Preferably, the second weight insert comprises a body portion formed about an annular metal member. The metal members may be made from a metal selected from the group comprising steel and aluminium.

Preferably, the body is provided with one or more grooves in the surface thereof, the one or more grooves being substantially parallel to the longitudinal axis of the body.

In one preferred embodiment, one of the first end of the body and second end of the handle is provided with a threaded projection which is adapted to cooperate with a corresponding threaded bore in the other of the first end of the body and second end of the handle.

In another preferred embodiment the body includes an elongate projection extending from the first end of the body in a direction substantially parallel to the longitudinal axis of the body, and wherein the handle is in the form of a cylindrical member adapted to be received on the elongate projection. The handle is removably attached to the body by the first weight insert.

Preferably, the third weight insert is the striking tip of the drumstick.

Preferably, the drumstick is provided with a number of interchangeable first, second and third weight inserts, each insert having a different mass.

Preferably, at least one of said body and handle is manufactured from a plastics polymer material. Most preferably, each of said body and handle are manufactured from the plastics polymer material.

Preferably, the plastics polymer material is selected from the group comprising nylon and polycarbonate composite materials.

A preferred embodiment of the present invention will now be described, by way of example only, with reference to the accompanying drawings, in which:

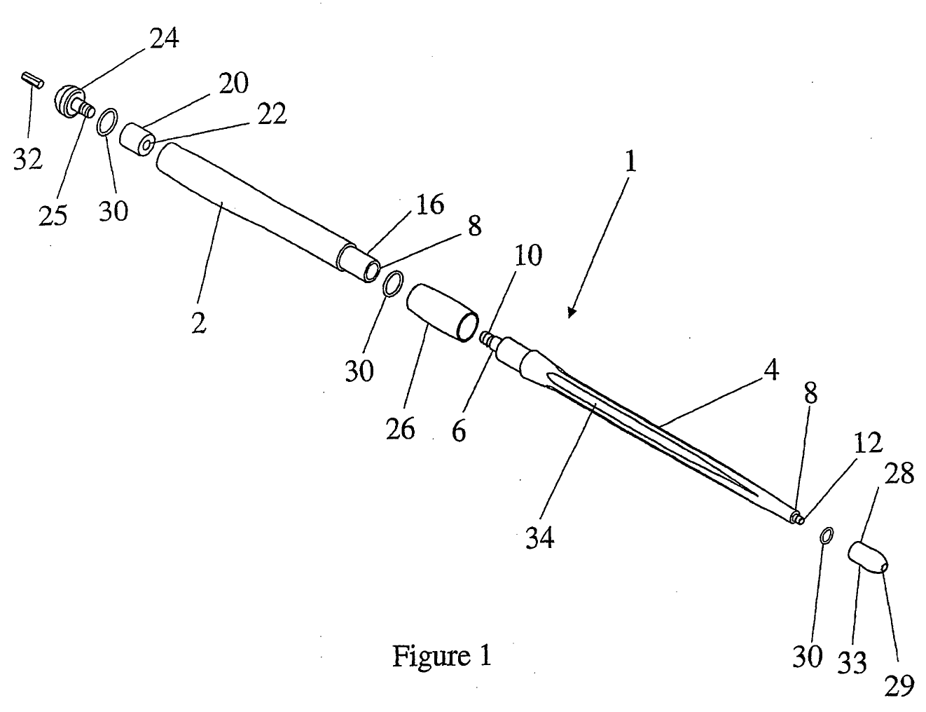

FIG. 1 shows an exploded projection view of a first embodiment of a modular drumstick;

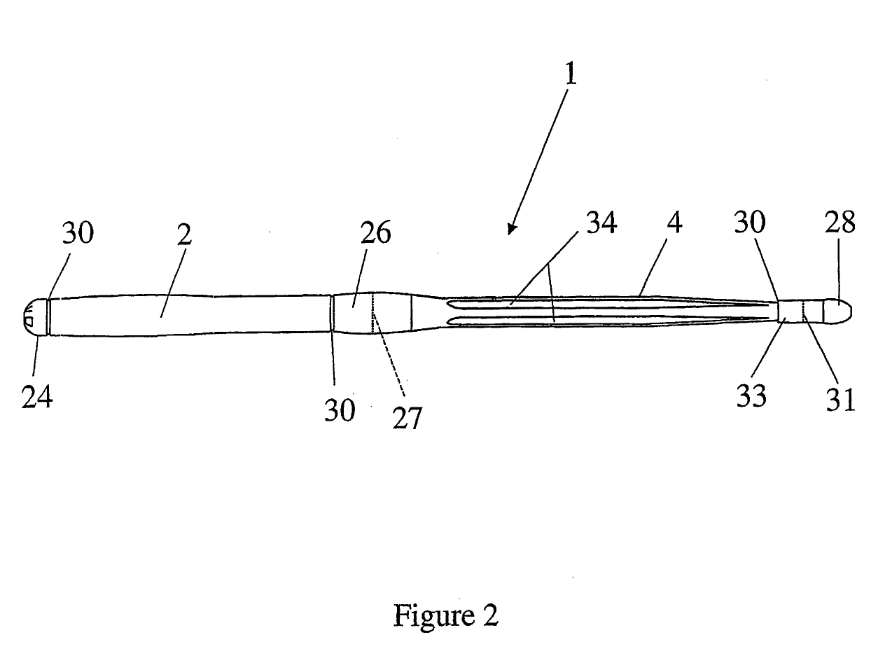

FIG. 2 shows a side elevation of the complete drumstick shown in FIG. 1;

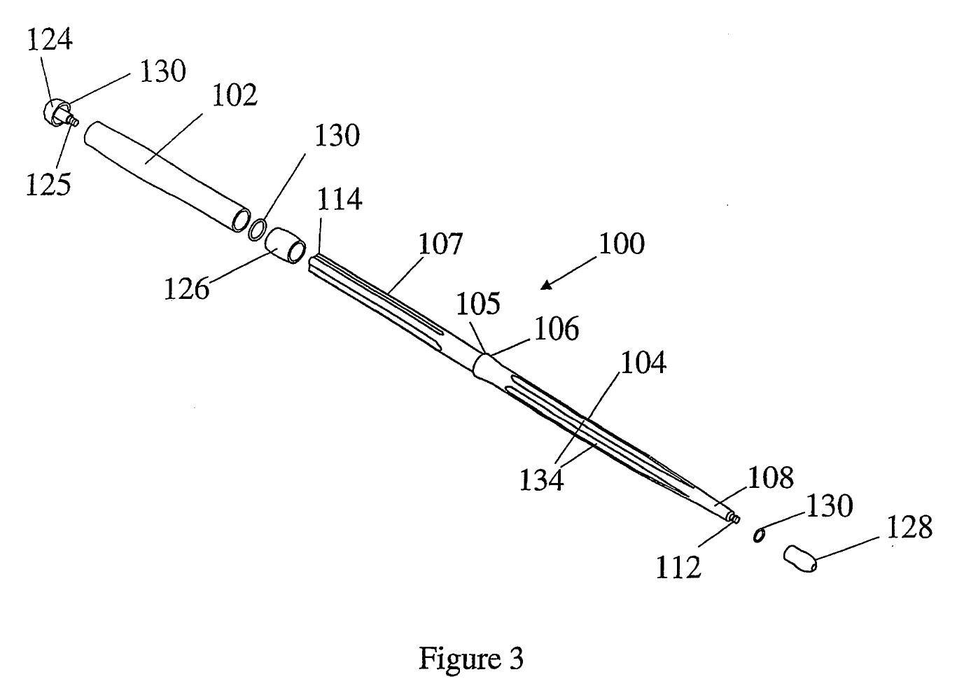

FIG. 3 shows an exploded projection view of a second embodiment of a modular drumstick; and

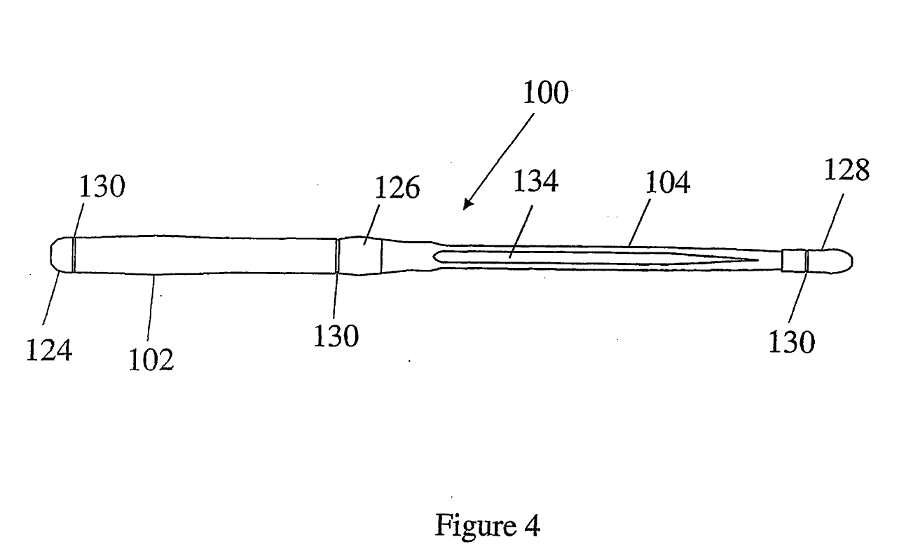

FIG. 4 shows a side elevation of the complete drumstick shown in FIG. 3.

As shown in FIGS. 1 and 2, a modular drumstick 1 made from a plastics polymer material comprises two main components: a handle 2 and an elongate body, or frontstick, 4. The frontstick 4 has a first end 6 adjacent the handle 2 and a second end 8 remote from the handle 2. Both the first and second ends 6,8 of the frontstick 4 have externally threaded projections 10,12. The handle 2 is provided with a first end 14 remote from the frontstick 4 and a second end 16 adjacent the first end 6 of the frontstick 4. The first end 14 of the handle 2 is provided with an insert 20 which has a threaded bore 22. The insert 20 is fixed within the first end 14 of the handle 2 using any conventional means or else the handle 2 and insert 20 may be integrally formed. The second end 16 of the handle 2 is provided with an internally threaded portion 18 which is adapted to receive the externally threaded projection 10 of the frontstick 4.

The drumstick 1 is also provided with three interchangeable weight inserts which are attached to the drumstick at the first end 14 of the handle 2, between the handle 2 and frontstick 4, and at the second end 8 of the frontstick 4, respectively. The first weight insert is in the form of a plug 24 which has an externally threaded portion 25 which is received within the threaded bore 22 of the insert 20. An O-ring 30 is provided between the plug 24 and handle 2 to assist in damping vibration so that the plug 24 does not unscrew itself during prolonged use of the drumstick 1. A number of plugs 24 are provided with the stick 1, each having a different mass. In a preferred embodiment, three plugs of different mass are provided: one standard plug 24 and two plugs 24 having an metal member 32 fixed in a bore (not shown) in the top of the plug 24. The metal members 32 for the two non-standard plugs are made from steel and aluminium, respectively. Thus, plugs 24 having three different masses are provided which may be interchanged as desired.

The second weight insert is in the form of a sleeve 26 which locates between the handle 2 and frontstick 4. The sleeve 26 can be slid over either the second end 16 of the handle 2 or first end 6 of the frontstick 4 prior to the handle 2 and frontstick 4 being screwed together. The sleeve 26 is therefore located over the join 27 between the handle 2 and frontstick 4 and therefore strengthens the join 27 between the two components. An O-ring 30 is provided between the sleeve 26 and handle 2 to damp vibrations. As with the plug 24, three sleeves of different mass are provided with the stick 1: one standard sleeve and two non-standard sleeves, each of the non-standard sleeves having either a steel or aluminium ring (not shown) about which the sleeve is formed to provide the additional mass.

The third weight insert is in the form of the striking tip 28 of the stick 1. The striking tip 28 is internally threaded and is received upon the threaded projection 12 of the second end of the frontstick 4, again with an O-ring 30 provided for damping. As with both the plug 24 and sleeve 26, the striking tip 28 is provided in three differing masses, with a bore 29 therein into which is fixed either a steel or aluminium insert (not shown) for the two non-standard striking tips. As before, the standard tip has no insert. As can be seen best in FIG. 2, the tip 28 has a sleeve portion 33. When it is attached to the frontstick 4, the sleeve portion 33 covers the join 31 and O-ring 30 between the second end 8 of the frontstick 4 and the tip 28 itself so as to add strength to the join 31.

It can also be seen from FIG. 2 that the frontstick 4 of this particular embodiment is provided with a number of longitudinal grooves 34 cut into the circumference of the frontstick 4. By providing the grooves 34 in the frontstick 4, the stiffness of the frontstick 4 can be varied, with the result that the rebound characteristics of the stick 1 can be adjusted.

A second embodiment of a modular drumstick will now be described with reference to FIGS. 3 and 4. The drumstick 100 comprises a handle 102 and a frontstick 104. The frontstick 104 has a first end 106 adjacent the handle 102 and a second end 108 remote from the handle 102. Where the second embodiment differs from the first embodiment of the drumstick is that in the second embodiment, the frontstick 104 has an integral projection 107 which extends longitudinally from the first end 106 of the frontstick 104.

The drumstick 100 is also provided with three interchangeable weights which are attached to the drumstick 100 at the end 114 of the projection 107 remote from the frontstick 104, between the handle 102 and frontstick 104, and at the second end 108 of the frontstick 104, respectively. The weights comprise a plug 124, a sleeve 126 and a striking tip 128 as described with respect to the first embodiment. As with the first embodiment, the different masses of the plug 124, sleeve 126 and tip 128 are achieved by providing metal inserts of steel or aluminium in the weights.

To fit the second embodiment of the drumstick 100 together, first the sleeve 126 is slid onto the projection 107 until it abuts a rib 105 which denotes the first end 106 of the frontstick 104. Then, an O-ring 130 is also slid onto the projection 107 to provide damping for the drumstick 100 before the handle 102 is finally also slid onto the projection 107 until it abuts the O-ring 130 and sleeve 126. Once the sleeve 126, O-ring 130 and handle 102 are in position, the plug 124 is attached to the end 114 of the projection 107 via an externally threaded portion 125 which is received in a corresponding internally threaded bore (not shown) in the end 114 of the projection 107. Another O-ring 130 is provided on the plug 124 so as to damp vibrations and ensure that the plug 124 does not fall out of the projection 107. With the plug 124 attached to the projection 107, the sleeve 126 and handle 102 are fixed on the projection 107 and cannot be removed unless the plug 124 is removed. The striking tip 128 is threaded onto an externally threaded portion 112 of the second end 108 of the frontstick 104 in the same manner as in the first embodiment, with another O-ring 130 provided for additional damping.

With the provision of the integral projection 107 and frontstick 104, there is no structural join between the handle 102 and frontstick 104 and so, therefore, the strength of the drumstick 100 is still further increased. As with the first embodiment, longitudinal grooves 134 can be provided in the circumference of the frontstick 104 to vary the stiffness of the frontstick 104, with the result that the rebound of the stick 100 can be adjusted.

In the embodiments described above, both the handles and frontsticks are made from the same plastics polymer material. The preferred material is nylon or polycarbonate filled with either carbon fibre or glass fibre.

The weight inserts described above in respect of both the first and second embodiments allow the user to vary the overall weight and the centre of gravity of the drumstick. This allows a tuning process of optimising acoustic characteristics with the desired ergonomic handling of the drumstick. The weight inserts may be marked with a weight number, which enables the user to view a look up table. This look up table highlights a list of preferred weight combinations to suit various playing styles.

The user can select his own weight set to suit individual preferences for weight, balance and musical situation. This may include practice situations where playing with an increased stick moment about the grip point will increase wrist development. This is particularly useful for tutors in developing rudimentary drum technique and the wrist development of students, while recognising individual student limitations and requirements.

Another advantage of the process of controlling overall drumstick design is the ability for the user to optimise the drumstick to reduce unnecessary out of balance forces, control the dynamics and feel of the unit to suit the situation, and thus reduce the forces on the wrist and the incidence of repetitive strain injury.

The frontstick and striking tip can be removed and replaced with a variety of alternative striking elements or accessories to suit the musical situation. Examples of the accessories could be a brush, a beater head or mallet.

It should also be noted that the frontstick may be provided with an outer protective sleeve or coating, which can be replaced as required if damaged or worn through the action of cymbal or rim shot strikes, for example.

The grooves provided in the frontstick may be in the form of helical grooves extending along the length of the frontstick, or as a number of individual circumferential grooves at various points along the length of the frontstick. The length and/or number of these grooves may be varied depending on the requirements of the user. An alternative manner of varying the stiffness is to bore holes perpendicular to the longitudinal axis of the frontstick at various points, with the holes being either blind.or extending all the way through the frontstick.

In addition, other suitable materials may be used for one or more of the components of the drumstick. For example, the handle and frontstick components may be manufactured from wood or aluminium rather than the plastics material referred to in the specific description. Furthermore, it should be noted that any suitable metals may be used for the different masses in the inserts other than steel and aluminium, if desired.

Although the plugs and striking tips described above have weight inserts fixed therein, the inserts may also be removable from the plugs, sleeves and tips. Thus, only one plug, sleeve and tip would be required with the inserts being interchanged as desired. The different masses for the plug and striking tip may also be achieved by using a metal ring around which the plug or tip is formed. As a further alternative, the rings may be separate from the plug and tip and simply located on the respective end of the handle or frontstick and secured thereto by the plug or tip, respectively. Furthermore, the drumstick may be reversed such that the plug may be used as the striking tip.

Modifications and improvements can be incorporated without departing from the scope of the invention.

1. A modular drumstick comprising:
an elongate body having a first end and a second end;
an elongate handle having a first end and a second end;
wherein the first end of the body and second end of the handle are adapted so that the handle may be removably attached to the body such that the first end of the body and second end of the handle are connected to one another; and
the drumstick further comprising first, second and third weight inserts which are adapted to be removably attached to the drumstick at first, second and third locations, respectively, along the length thereof.

2. The modular drumstick of claim 1, wherein the first location is adjacent the first end of the handle.

3. The modular drumstick of claim 1, wherein the second location is adjacent the second end of the handle and the first end of the body.

4. The modular drumstick of claim 1, wherein the third location is adjacent the second end of the body.

5. The modular drumstick of claim 1, wherein an annular damping member is provided between at least one of the weight inserts and the drumstick.

6. The modular drumstick of claim 1, wherein the first and third weight inserts are provided with chambers into which may be inserted metal members of differing mass.

7. The modular drumstick of claim 6, wherein the metal members are made from a metal selected from the group comprising steel and aluminum.

8. The modular drumstick of claim 1, wherein the second weight insert comprises a body portion formed about an annular metal member.

9. The modular drumstick of claim 8, wherein the annular metal member is made from a metal selected from the group comprising steel and aluminum.

10. The modular drumstick of claim 1, wherein the body is provided with one or more grooves in the surface thereof, the one or more grooves being substantially parallel to the longitudinal axis of the body.

11. The modular drumstick of claim 1, wherein one of the first end of the body and second end of the handle is provided with a threaded projection which is adapted to cooperate with a corresponding threaded bore in the other of the first end of the body and second end of the handle.

12. The modular drumstick of claim 1, wherein the body includes an elongate projection extending from the first end of the body in a direction substantially parallel to the longitudinal axis of the body, and wherein the handle is in the form of a cylindrical member adapted to be received on the elongate projection.

13. The modular drumstick of claim 12, wherein the handle is removably attached to the body by the first weight insert.

14. The modular drumstick of claim 1, wherein the third weight insert is the striking tip of the drumstick.

15. The modular drumstick of claim 1, wherein the drumstick is provided with a number of interchangeable first, second and third weight inserts, each insert having a different mass.

16. The modular drumstick of claim 1, wherein at least one of said body and handle is manufactured from a plastics polymer material.

17. The modular drumstick of claim 16, wherein said plastics polymer material is selected from the group comprising nylon and polycarbonate composite materials.
